(19) United States
(12) Patent Application Publication
(10) Pub. No.: US 2012/0112659 A1
(43) Pub. Date: May 10, 2012

(54) LED Circuit Having LED Driving Circuit and Operation Method of the Same

(75) Inventor: Kuan-Jen Tseng, Sinshih Township (TW)

(73) Assignee: HIMAX ANALOGIC, INC., Sinshih Township (TW)

(21) Appl. No.: 12/939,303

(22) Filed: Nov. 4, 2010

(51) Int. Cl. H05B 37/02

(52) U.S. Cl. 315/294

(57) ABSTRACT

A LED circuit is provided. The LED circuit comprises LED channels and a LED driving circuit. The LED driving circuit comprises: a current mirror, a dc-to-dc converter and current sink modules each connected between one of the LED channels and an output load to lock the voltage at the output load at a level of a setting voltage. The current mirror comprises an input branch to generate an input setting current according to a variable setting load and an output branch to generate an output setting current to further generate a variable reference voltage and the setting voltage. A control module of the dc-to-dc converter generates a driving voltage according the variable reference voltage and a feedback voltage to control a gate of the power MOS of the dc-to-dc converter to further control the operation of the LED channels. A LED circuit operation method is disclosed herein as well.

### BACKGROUND

1. Technical Field

The present disclosure relates to a LED circuit. More particularly, the present disclosure relates to a LED circuit having a LED driving circuit and the operation method of the same.

2. Description of Related Art

LEDs are estimated to be four times as efficient as conventional incandescent lights. They are also claimed to be more economically sound than compact fluorescent bulbs that contain harmful mercury and are supposed to last a lot longer than the conventional lighting. Thus, LEDs may become the mainstream of the lighting technology.

Current sink circuits are adapted to the LED channels of the LED circuit to provide a stabilization mechanism. When a feedback voltage from the output node of one of the LED channels is used to compare with a fixed reference voltage to accomplish a feedback control mechanism, the voltage at the output node is kept around the reference voltage. When the operation mode of the LED channels makes the LED current of each of the LED channels smaller, the heat generated at the current sink module does not degrade a lot due to the fixed reference voltage.

Accordingly, what is needed is a LED circuit having a LED driving circuit and the operation method of the same to overcome the above issue. The present disclosure addresses such a need.

### SUMMARY

An aspect of the present disclosure is to provide a LED driving circuit to drive a plurality of LED channels. The LED driving circuit comprises: a plurality of current sink modules, a current mirror and a dc-to-dc converter. Each of the current sink modules is connected between one of the LED channels and an output load to lock the voltage at the output load at a level of a setting voltage. The current mirror comprises an input branch and an output branch. The input branch generates an input setting current according to a variable setting load. The output branch generates an output setting current comprising a first load and a second load connected in series to generate a variable reference voltage and the setting voltage according to the output setting current respectively. The dc-to-dc converter comprises a control module and a power MOS connected to the LED channels, wherein the control module generates a driving voltage according the variable reference voltage and a feedback voltage from one of the output nodes of the LED channels to control a gate of the power MOS to further control the operation of the LED channels.

Another aspect of the present disclosure is to provide a LED circuit comprising: a plurality of LED channels and a LED driving circuit. The LED driving circuit comprises: a plurality of current sink modules, a current mirror and a dc-to-dc converter. Each of the current sink modules is connected between one of the LED channels and an output load to lock the voltage at the output load at a level of a setting voltage. The current mirror comprises an input branch and an output branch. The input branch generates an input setting current according to a variable setting load. The output branch generates an output setting current comprising a first load and a second load connected in series to generate a variable reference voltage and the setting voltage according to the output setting current respectively. The dc-to-dc converter comprises a control module and a power MOS connected to the LED channels, wherein the control module generates a driving voltage according the variable reference voltage and a feedback voltage from one of the output nodes of the LED channels to control a gate of the power MOS to further control the operation of the LED channels.

Yet another aspect of the present disclosure is to provide a LED circuit operation method adapted in a LED circuit, wherein the LED circuit comprises a plurality of LED channels, the LED circuit operation method comprises the steps as follows. An input setting current at an input branch of a current mirror is generated according to a variable setting load. An output setting current is generated according to the input setting current at an output branch of the current mirror comprising a first load and a second load connected in series to generate a variable reference voltage and a setting voltage according to the output setting current respectively. A voltage at an output load connected to one of the LED channels is locked at a level of the setting voltage. The variable reference voltage and a feedback voltage from one of the output nodes of the LED channels is received to a control module of the LED circuit to control a gate of a power MOS of the LED circuit to further control the operation of the LED channels.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a diagram of a LED circuit of an embodiment of the present disclosure;

FIG. 2 is a detailed diagram of the current mirror, two of the LED channels and two of the current sink modules in an embodiment of the present disclosure;

FIG. 3 is a further detailed diagram of the current sink module and the output load in an embodiment of the present disclosure; and

FIG. 4 is a flow chart of a LED circuit operation method of an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

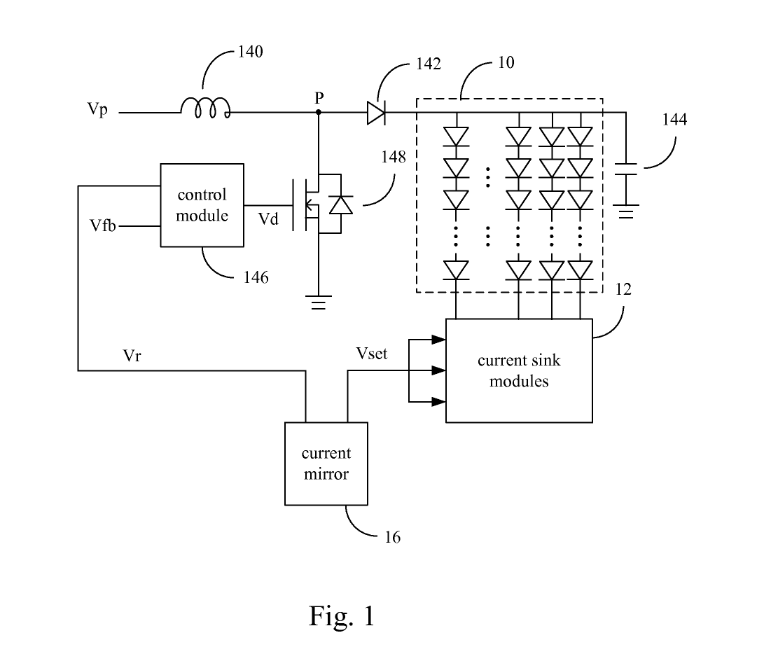

Please refer to FIG. 1. FIG. 1 is a diagram of a LED circuit 1 of an embodiment of the present disclosure. The LED circuit 1 comprises a plurality of LED channels 10 and a LED driving circuit. The LED driving circuit comprises a plurality of current sink modules 12, a dc-to-dc converter and a current mirror 16.

The dc-to-dc converter comprises an inductor 140, a diode 142, a capacitor 144, a control module 146 and a power MOS 148.

The inductor 140 couples a supply voltage Vp to a first node P. The diode 142 is connected between the first node P and the LED channels 10, wherein the anode of the diode 142 is connected to the first node P, and the cathode of the diode 14 is connected to the capacitor 144. The capacitor 144 is connected to the LED channels 10. It's noticed that the number of the LED channels 10 and the number of LED in each channel can be different in various embodiments.

In an embodiment, the control module 146 may comprise an error amplifier and a pulse width modulator (not shown). The error amplifier generates a comparison result according to a reference voltage Vr and a feedback voltage Vfb related to the LED channels 10. The pulse width modulator further generates a driving voltage Vd. When the driving voltage Vd turns high, the power MOS 148 turns on. When the driving voltage Vd turns low, the power MOS 148 turns off. The power MOS 148 thus is operative to be turned on and off to charge or discharge the capacitor 144 so that the LED channels 10 turn on and off according to the charging and discharging activities of the capacitor 144.

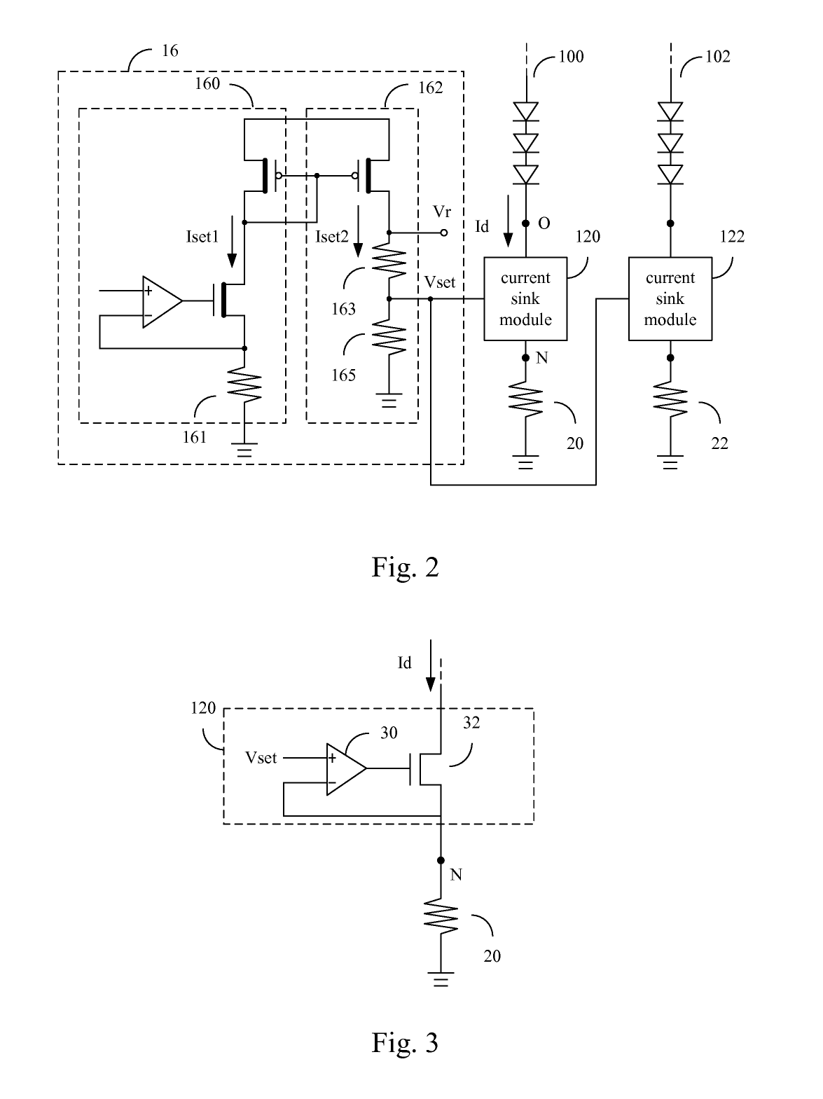

Each of the current sink modules 12 is connected to one of the LED channels 10 to provide a stabilization mechanism. Please refer to FIG. 2 at the same time. FIG. 2 is a detailed diagram of the current mirror 16, two of the LED channels 100 and 102 and two of the current sink modules 120 and 122.

The current sink module 120 is connected between the LED channel 100 and an output load 20. The current sink module 122 is connected between the LED channel 102 and an output load 22. Please refer to FIG. 3 at the same time. FIG. 3 is a further detailed diagram of the current sink module 120 and the output load 22. The current sink module 120 comprises an operational amplifier 30 and a switch MOS 32. The switch MOS 32 is connected between the corresponding LED channel 100 and the output load 20. The operational amplifier 30 has a positive input end to receive a setting voltage Vset, a negative input end connected to the output load 20 and the switch MOS 32 to lock the voltage of the output load 20, which is the voltage at node N, at the level of the setting voltage Vset. The operational amplifier 30 further has an output end connected to the gate of the switch MOS 32.

The current mirror 16 comprises an input branch 160 and an output branch 162. The input branch 160 generates an input setting current Iset1 according to a variable setting load 161. In other words, the variable setting load 161 can be a variable resistor such that a user can adjust its resistance to modify the input setting current Iset1. The output branch 162 thus generates an output setting current Iset2 according to the input setting current Iset1.

The output branch 162 comprises a first load 163 and a second load 165 connected in series. In the present embodiment, both the first load 163 and the second load 165 are resistors. Accordingly, two voltages are generated first load 163 and the second load 165 respectively.

The voltage at the second load 165 is used as the setting voltage Vset and is sent to the positive input end of the operational amplifier of each of the current sink modules 120 and 122 to provide the voltage locking mechanism. Due to the voltage locking mechanism, the output setting current Iset2 and the LED current of each of the LED channels, such as the LED current Id depicted in FIG. 2 and FIG. 3, has a current ratio the same with the resistance ratio with respect to the second load 165 and the output load. For example, when the resistance of the output load 20 is R1 and the resistance of the second load 165 is 200*R1, the current ratio between the output setting current Iset2 and the LED current Id is 200 as well.

The voltage at the first load 163 is used as a variable reference voltage Vr that is sent to the control module 146 as depicted in FIG. 1. Therefore, the control module 146 substantially generates the driving voltage Vd according to the variable reference voltage Vr and the feedback voltage Vfb. It's noticed that the feedback voltage Vfb is generated according to one of the output nodes of the LED channels 10, such as the output node 0 of the LED channel 100. In an embodiment, the feedback voltage Vfb can be selected from the voltages of the output nodes by a minimum-selecting mechanism.

Consequently, when the resistance of the variable setting load 161 is adjusted, the output setting current Iset2 is varied according to the modified input setting current Iset1. The varied output setting current Iset2 further makes the variable reference voltage Vr and the LED current Id varies as well.

In an example, the LED current Id is 40 mA, and the variable reference voltage Vr is 0.8 v at first. If the operation mode of the LED circuit 1 is changed because the variable setting load 161 is adjusted to a lower value such that the LED current Id turns to 20 mA, the power dissipation will be higher if a fixed reference voltage is adapted in the control module 146 because the feedback control mechanism tends to fix the voltage at the output node of the LED channels at a value (e.g. 0.8 v) the same with the previous operation mode.

If the variable reference voltage Vr is used as described above, the feedback control mechanism can fix the voltage at the output node of the LED channels at a lower value (e.g. 0.6 v) due to the lower reference voltage Vr that is modified according to the lower resistance of the variable setting load 161 to make the power dissipation lower.

For example, in the previous operation mode, the feedback control mechanism makes the output node of the LED channels fix at 0.8 v, the power dissipation is 0.8 (v)*40 (mA). If the fixed reference voltage is adapted, the power dissipation in the later operation mode is 0.8 (v)*20 (mA). On the other hand, if the variable reference voltage in the present disclosure is adapted, the power dissipation in the later operation mode is 0.6 (v)*20 (mA). When the power dissipation of the current sink module in all the LED channels can be decreased due to the variable reference voltage, the total power dissipation can be greatly reduced.

It's noticed that though there are only two LED channels are shown in FIG. 2, the number of the LED channels can be adjusted in different embodiments depending on different situations.

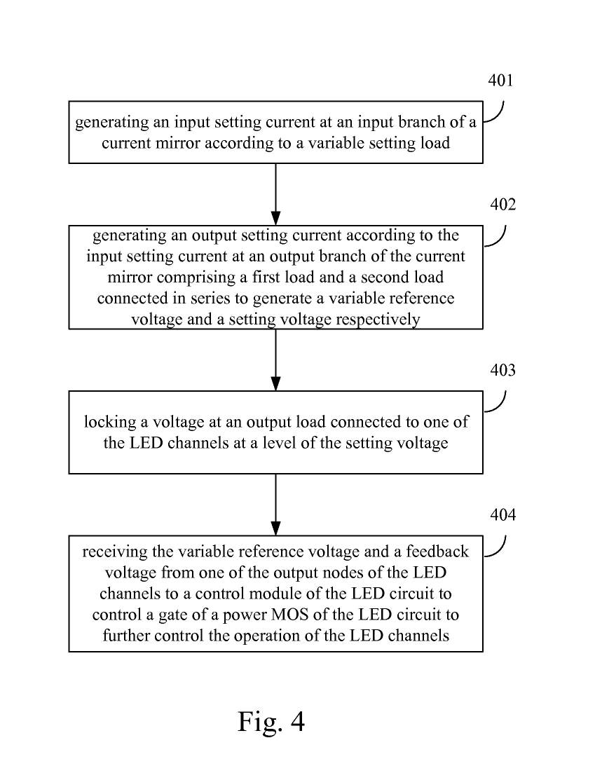

Please refer to FIG. 4. FIG. 4 is a flow chart of a LED circuit operation method of an embodiment of the present disclosure. The LED circuit operation method can be adapted in the LED circuit 1 depicted in FIG. 1. The LED circuit operation method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 401, an input setting current Iset1 at an input branch 160 of a current mirror 16 is generated according to the variable setting load 161. An output setting current Iset2 is generated according to the input setting current Iset1 at an output branch 162 of the current mirror 16 comprising a first load 163 and a second load 165 connected in series to generate the variable reference voltage Vr and the setting voltage Vset according to the output setting current Iset2 respectively in step 402. In step 403, the voltage at the output load connected to one of the LED channels 10 is locked at a level of the setting voltage Vset. The variable reference voltage Vr and a feedback voltage Vfb from one of the output nodes of the LED channels 10 is received to the control module 146 of the LED circuit 1 to control the gate of the power MOS 148 of the LED circuit 1 to further control the operation of the LED channels 10.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A LED driving circuit to drive a plurality of LED channels, wherein the LED driving circuit comprises:
a plurality of current sink modules each connected between one of the LED channels and an output load to lock the voltage at the output load at a level of a setting voltage;
a current mirror comprising:
an input branch to generate an input setting current according to a variable setting load; and
an output branch to generate an output setting current comprising a first load and a second load connected in series to generate a variable reference voltage and the setting voltage according to the output setting current respectively;
a dc-to-dc converter comprising a control module and a power MOS connected to the LED channels, wherein the control module is to generate a driving voltage according the variable reference voltage and a feedback voltage from one of the output nodes of the LED channels to control a gate of the power MOS to further control the operation of the LED channels.

2. The LED driving circuit of claim 1, wherein the variable reference voltage is varied when a resistance of the setting load is varied to make the input setting current vary such that the output setting current varies according to the input setting current.

3. The LED driving circuit of claim 1, wherein each of the current sink modules comprises:
a switch MOS connected between the corresponding one of the LED channel and the output load; and
an operational amplifier having:
a positive input end to receive the setting voltage;
a negative input end connected to the output load and the switch MOS to lock the voltage of the output load at the level of the setting voltage; and
an output end connected to the gate of the switch MOS.

4. The LED driving circuit of claim 1, wherein a current ratio with respect to the output setting current and a LED current of each of the LED channels is the same with a resistance ratio with respect to the second load and the output load.

5. The LED driving circuit of claim 1, wherein the first load is a resistor or a diode.

6. The LED driving circuit of claim 1, wherein the dc-to-dc converter further comprises:
an inductor coupled a supply voltage to a first node;
a diode connected between the first node and the LED channels; and
a capacitor connected to the LED channels, wherein the power MOS is substantially connected to the first node to charge or discharge the capacitor according to the driving voltage.

7. The LED driving circuit of claim 6, wherein an anode of the diode is connected to the first node, and a cathode of the diode is connected to the capacitor.

8. A LED circuit comprising:
a plurality of LED channels; and
a LED driving circuit comprises:
a plurality of current sink modules each connected between one of the LED channels and an output load to lock the voltage at the output load at a level of a setting voltage;
a current mirror comprising:
an input branch to generate an input setting current according to
a variable setting load; and
an output branch to generate an output setting current comprising a first load and a second load connected in series to generate a variable reference voltage and the setting voltage according to the output setting current respectively;
a dc-to-dc converter comprising a control module and a power MOS connected to the LED channels, wherein the control module is to generate a driving voltage according the variable reference voltage and a feedback voltage from one of the output nodes of the LED channels to control a gate of the power MOS to further control the operation of the LED channels.

9. The LED circuit of claim 8, wherein the variable reference voltage is varied when a resistance of the setting load is varied to make the input setting current vary such that the output setting current varies according to the input setting current.

10. The LED circuit of claim 8, wherein each of the current sink modules comprises:
a switch MOS connected between the corresponding one of the LED channel and the output load; and
an operational amplifier having:
a positive input end to receive the setting voltage;
a negative input end connected to the output load and the switch MOS to lock the voltage of the output load at the level of the setting voltage; and
an output end connected to the gate of the switch MOS.

11. The LED circuit of claim 8, wherein a current ratio with respect to the output setting current and a LED current of each of the LED channels is the same with a resistance ratio with respect to the second load and the output load.

12. The LED circuit of claim 8, wherein the first load is a resistor or a diode.

13. The LED circuit of claim 8, wherein the dc-to-dc converter further comprises:
an inductor coupled a supply voltage to a first node;
a diode connected between the first node and the LED channels; and
a capacitor connected to the LED channels, wherein the power MOS is substantially connected to the first node to charge or discharge the capacitor according to the driving voltage.

14. The LED circuit of claim 13, wherein an anode of the diode is connected to the first node, and a cathode of the diode is connected to the capacitor.

15. A LED circuit operation method adapted in a LED circuit, wherein the LED circuit comprises a plurality of LED channels, the LED circuit operation method comprises the steps of:
generating an input setting current at an input branch of a current mirror according to a variable setting load;
generating an output setting current according to the input setting current at an output branch of the current mirror comprising a first load and a second load connected in series to generate a variable reference voltage and a setting voltage according to the output setting current respectively;
locking a voltage at an output load connected to one of the LED channels at a level of the setting voltage; and
receiving the variable reference voltage and a feedback voltage from one of the output nodes of the LED channels to a control module of the LED circuit to control a gate of a power MOS of the LED circuit to further control the operation of the LED channels.

16. The LED circuit operation method of claim 15, further comprising the steps of:
varying a resistance of the setting load to make the input setting current vary; and
varying the output setting current according to the input setting current to vary the variable reference voltage.

17. The LED circuit operation method of claim 15, wherein a current ratio with respect to the output setting current and a LED current of each of the LED channels is the same with a resistance ratio with respect to the second load and the output load.
